(19) United States
(12) Patent Application Publication
(10) Pub. No.: US 2013/0066859 A1
(43) Pub. Date: Mar. 14, 2013

(54) SYSTEM AND METHOD FOR ANALYZING FITNESS CHARACTERISTICS

(71) Applicant: Steven Young, Voorhees, NJ (US)

(72) Inventor: Steven Young, Voorhees, NJ (US)

(21) Appl. No.: 13/228,266

(22) Filed: Sep. 8, 2011

(51) Int. Cl. G06F 17/30

(52) U.S. Cl. 707/723; 707/E17.014

(57) ABSTRACT

The present invention generally relates to fitness analysis. Specifically, this invention relates to a system and method for analyzing the readiness of an individual to perform one or more physical activities by testing and measuring performance of the individual, generating results and comparing the results to a degree of difficulty associated with said one or more physical activities.

### FIELD OF THE INVENTION

The present invention generally relates to fitness analysis. Specifically, this invention relates to a system and method for analyzing the readiness of an individual to perform one or more physical activities by testing and measuring performance of the individual, generating results and comparing the results to a degree of difficulty associated with said one or more physical activities.

### BACKGROUND OF THE INVENTION

Exercise and physical activity, being an important part of life, is engaged in by countless individuals every day. Many individuals take it upon themselves to start or engage in new exercise regimens without understanding the physical requirements of such a regimen. Even those individuals who engage professional help (e.g., personal trainers) may not be aware or made aware of their true and safe physical capabilities are.

Exercise regimens can be strenuous, and if not executed properly, can be harmful and even dangerous to the individual executing the regimen. Even where an individual can perform a specific regimen or exercise, it does not mean that the regimen or exercise is suitably tailored or recommended for that individual. Improper exercises can be performed by the individual without immediate symptoms of pain but can lead to serious injuries as that movement repeatedly causes progressive damage to the joints. Injuries are common occurrences in these cases and such injuries can lead to long periods of downtime for recovery, unnecessary medical expenses, and end up resulting in overall lowered physical capabilities. In some cases, permanent injuries can result.

While numerous attempts have been made to classify the difficulty of particular exercises, the degree of difficulty of an exercise is not just based on the exercise itself, but also the physical characteristics of an individual as well. For instance, long distance runners may be overall be identified as athletic and “in shape”, but they may lack the upper body strength and flexibility required for a particular upper body weightlifting routine. Without proper identification of the degree of difficulty of an exercise based on certain objective and measureable characteristics of the exercise and the requirements placed on the individual to complete the exercise, no true difficulty can be assessed with relation to that exercise.

Therefore, there is a need in the art for a system and method for analyzing the difficulty level of exercises and analyzing the physical characteristics of an individual and determining if specific exercises are appropriate for the individual. These and other features and advantages of the present invention will be explained and will become obvious to one skilled in the art through the summary of the invention that follows.

### SUMMARY OF THE INVENTION

Accordingly, it is an object of the present invention to provide a system and method for analyzing the difficulty level of exercises and analyzing the physical characteristics of an individual and determining one or more specific exercises that are appropriate for the individual.

According to an embodiment of the present invention, the system is configured to analyze the difficulty of an exercise based on two or more variables.

According to an embodiment of the present invention, the system is configured to measure the number of joints involved in a movement.

According to an embodiment of the present invention, the system is configured to measure the planes of motion (frontal, saggital, transverse) utilized in a movement.

According to an embodiment of the present invention, the system is configured to measure the speed of a movement.

According to an embodiment of the present invention, the system is configured to measure the stability of an exercise.

According to an embodiment of the present invention, the system is configured to determine how taxing an exercise is on an individual's nervous system.

According to an embodiment of the present invention, the system is configured to set criteria for levels of difficulty.

According to an embodiment of the present invention, the system is configured to classify any exercise into a preconfigured difficulty level.

According to an embodiment of the present invention, the system is configured to test the physical characteristics of an individual. The system may use this information to determine if certain exercises are appropriate for that individual. The system may be further configured to determine an appropriate exercise routine for that individual.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates a schematic overview of a computing device, in accordance with an embodiment of the present invention;

FIG. 2 illustrates a flowchart for an exemplary method associated with analyzing a degree of difficulty of an exercise, in accordance with an embodiment of the present invention; and

FIG. 3 illustrates a flowchart for an exemplary method associated with analyzing a fitness level of an individual, in accordance with an embodiment of the present invention.

### DETAILED SPECIFICATION

The present invention generally relates to fitness analysis. Specifically, this invention relates to a system and method for analyzing the readiness of an individual to perform one or more physical activities by testing and measuring performance of the individual, generating results and comparing the results to a degree of difficulty associated with said one or more physical activities.

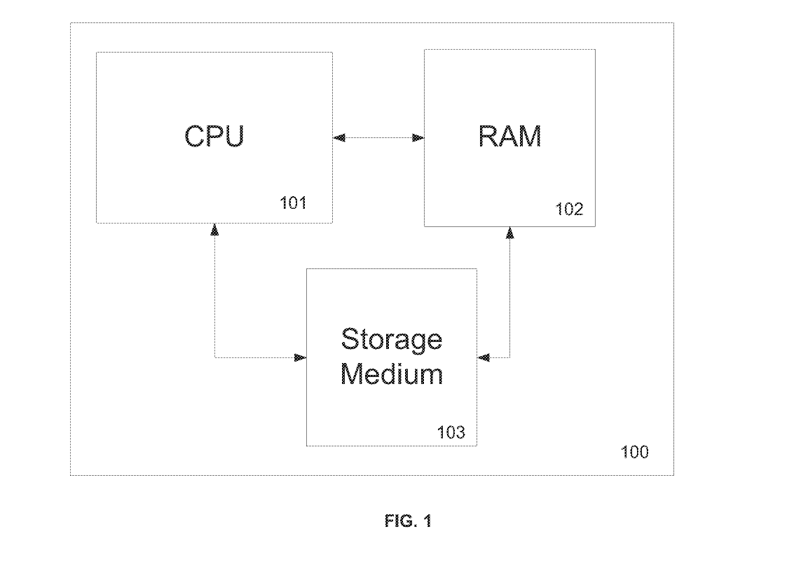

According to an embodiment of the present invention, the system and method is accomplished through the use of one or more computing devices. One of ordinary skill in the art would appreciate that a computing device (FIG. 1) appropriate for use with embodiments of the present application may generally be comprised of one or more of a Central processing Unit (CPU), Random Access Memory (RAM), and a storage medium (e.g., hard disk drive, solid state drive, flash memory, cloud storage). Examples of computing devices usable with embodiments of the present invention include, but are not limited to, personal computers, smart phones, laptops, mobile computing devices, and servers. In certain exemplary embodiments, processing, storage and analysis may happen locally, remotely, partially locally and partially remotely or any combination thereof. For instance, recordation of data may occur locally, with processing and storage of data occurring remotely (e.g., cloud storage and processing). One of ordinary skill in the art would understand that any number of computing devices could be used, and embodiments of the present invention are contemplated for use with any computing device.

According to an embodiment of the present invention, one or more computing devices may be configured to analyze the difficulty of one or more exercises, analyze the ability level of an individual, match individuals with appropriate exercises, generate specific exercise routines bases on the ability level of an individual or any combination thereof. The computing device may be optionally comprised of one or more additions that will be discussed later. These optional additions provide additional functionality and enhanced performance when utilized.

In order to analyze the difficulty of an exercise, the system is configured to analyze a plurality of variables associated with each exercise in order to associate a degree or level of difficulty with the exercise. In an exemplary embodiment, the basis of analyzing a difficulty of an exercise lies in four variables. By measuring the number of joints involved in a movement, the planes of motion (frontal, saggital, transverse), the speed of movement, and the stability of the exercise, you can determine how taxing that exercise is on a person's nervous system. An exercise that is more taxing on the nervous system is essentially more difficult to execute with proper technique. As any of the four variables increase in number (i.e. more joints moving, more speed, more planes of motion, and more unstable), the brain has to control more variables given a single exercise. By looking at exercises through this process and setting criteria for levels of difficulty, one can then classify any exercise into a corresponding difficulty level. In alternate embodiments of the present invention, fewer than four variables or more than four variables may be utilized as well.

According to an embodiment of the present invention, by utilizing a computing device with software stored in a tangible medium and with programmed parameters for each variable, the user can input any exercise, and the software will identify the proper difficulty classification. It should be noted that the importance, or weight, of any variable utilized may be modified or altered, either manually or dynamically, in order to appropriately calculate that variable's importance to the final difficulty classification.

The system requires input related to the variables and identification of the joints of the human body that are involved in a given exercise. In an exemplary embodiment of the present invention, these inputs can be provided directly by a user. In an alternate embodiment, one or more optional sensors can be used to view, record or otherwise monitor an exercise and automatically identify the variables and joints of the human body that are involved. Optional sensors include, but are not limited to, cameras, IR sensors, motion sensors and motion capture systems. One of ordinary skill in the art would appreciate that there are numerous types of sensors that may be utilized by embodiments of the present invention, and embodiments of the present invention are contemplated for use with any appropriate type of sensor.

As each joint is identified, the software generates a total number of Degrees of Freedom (DOF) involved with the exercise. The DOF is a biomechanics term used to describe how many variables of movement are involved in exercise. For example, the knee, a hinge joint and only flex and extend. Therefore, it has one DOF. The shoulder joint can flex and extend, rotate, and abduct and adduct. Therefore, it has 3 DOF. Each joint in the body has between one and three DOF (inclusive). The system is configured to calculate the total DOF in an exercise based on which body part(s) are involved. The body parts may be identified manually, or via one or more optional sensors as described above.

According to an embodiment of the present invention, the system is configured to analyze the movement speed of an exercise (e.g., is the movement a fast speed or slow speed exercise). As the movement speed increases, the body has to produce more acceleration and deceleration to complete an exercise. The amount of force required to retain control over one's body increases even if the resistance of the exercise is the same. Therefore, fast speed exercises are more taxing on the nervous system and more difficult to complete correctly. Accordingly, in most cases, the higher speed an exercise, the higher degree of difficulty. This is not always the case, for instance, extremely slow movement can increase the difficulty of an exercise if other forces are acting on body. In either case, the system can be configured to identify and analyze the degree of difficulty based on the movement speed of an exercise.

According to an embodiment of the present invention, the system may be configured to analyze which one or a combination of the three planes of motion does the exercise occur in (Frontal, Saggital, and Transverse). As the number of planes of motion increases, the nervous system has to work harder to control the motion in multiple directions. As exercises become more complex and involve more planes of motion, the brain has to control more variables of direction (e.g., is the exercise done on a stable or unstable base, is one leg used or two). Exercise performed on both legs on a stable surface requires less balance and neuromuscular control. Exercises performed on one leg or on unstable surfaces like a ball, foam, or suspension trainer, the nervous system now has to work harder to control for the instability.

According to an embodiment of the present invention, once the plurality of variables are entered into the software, the system is configured to classify the exercise into an exercise ranking classification. The exercise ranking classification system is based on the plurality of variables. The exercise ranking classification system can be based on a difficulty scale (e.g., easy to hard) a numeric scale (e.g., 1 to 100) or any other appropriate exercise ranking classification. One of ordinary skill in the art would appreciate that there are numerous exercise ranking classification systems that may be utilized with embodiments of the present invention, and embodiments of the present invention are contemplated for use with any appropriate exercise ranking classification system.

While there are four variables identified above, there are numerous other variables that may be utilized with embodiments of the present invention. Examples of variables that could be used with embodiments of the present invention include, but are not limited to, additional external resistance (e.g., weights, elastic belts), repetitions, duration, sustain, form and focus. One of ordinary skill in the art would appreciate that there are numerous variables that could be utilized with embodiments of the present invention, and embodiments of the present invention are contemplated for use with any appropriate variable.

According to an embodiment of the present invention, in order to match the proper exercise(s) to a person's skill level, a series of movement tests are administered. The tests are designed to examine the person's ability to control the plurality of variables described above. In an exemplary embodiment of the present invention, the system is configured to record each test in digital video or any form of digital graphic medium.

Optionally, the system can be configured to automatically analyze the digital video. For instance, motion analysis software may be utilized to pinpoint and analyze the person's performance on the test, especially as it relates to the plurality of variables used by the given system. Alternatively, the digital videos may be analyzed visually by a trained user of the system. In this embodiment, the trained user would pinpoint and analyze the person's performance on the test, especially as it relates to the plurality of variables used by the given system.

According to an embodiment of the present invention, the system is configured to rank the person taking the test based on their performance in relation to an individual ranking classification system. As with the exercise ranking classification system described above, the individual ranking classification system is designed to assign an appropriate rank or rating to the person (e.g., colored belts, grades, degrees, levels). One of ordinary skill in the art would appreciate that there are numerous individual ranking classification systems that may be utilized with embodiments of the present invention, and embodiments of the present invention are contemplated for use with any appropriate individual ranking classification system.

According to an embodiment of the present invention, the system is configured to match the person's individual ranking with appropriately ranked exercise(s) such that the exercises prescribed to the person match the rank of the person's skill level. In this manner, the safety and health of the person can be protected by allowing them to participate in exercises that are uniquely identified for their skill levels.

It is important to note that, in an exemplary embodiment of the present invention, a person may have different levels based upon different exercises or different regions of the body. For instance, a particular person may have a strong upper body ranking and a different lower body ranking In this manner, the system may be configured to analyze and identify exercises for a person based not only on a single overall ranking, but rankings given to one or more regions or areas of the person's body.

According to an embodiment of the present invention, the system may be further configured to generate entire exercise routines based on one or more rankings associated with the person. In this manner, once the person's fitness levels are identified, suitable exercise regimens may be planned out automatically by the system. In this manner, the person is provided with a full service workout routine that is uniquely developed for them based on their overall ranking or the rankings assigned to their one or more regions or areas of the person's body.

Exemplary Methods

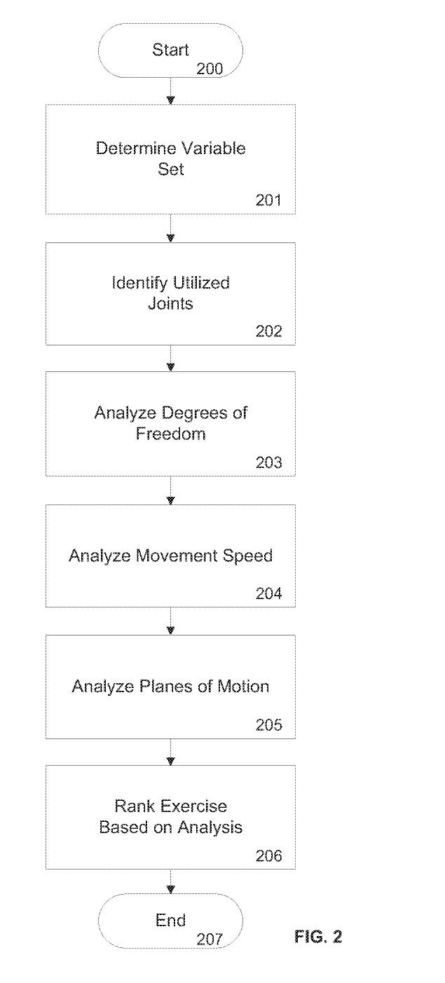

Turning now to FIG. 2, an exemplary embodiment of a method in accordance with the present invention is shown. The process starts at step 200, when the system is accessed by a user. At step 201, the variables to be used by the system are set. These may be preconfigured, manually configured or dynamically configured. For the purpose of this exemplary method, we will be assuming the use of four variables: number of joints, degrees of freedom, movement speed and planes of motion.

At step 202, the system identifies the joints utilized in the exercise. This can be provided manually by the user or generated automatically via one or more optional sensors as described above. Further, saved video or other data may be provided to the system and analyzed to identify the joints utilized in the exercise.

At step 203, the system analyzes the degrees of freedom of the exercise. This is determined from the utilized joints identified in step 202.

At step 204, the system analyzes the movement speed of the exercise. This can be provided manually by the user or generated automatically via one or more optional sensors as described above. Further, saved video or other data may be provided to the system and analyzed to determine the movement speed of the exercise.

At step 205, the system analyzes the planes of motion of the exercise. This can be provided manually by the user or generated automatically via one or more optional sensors as described above. Further, saved video or other data may be provided to the system and analyzed to determine the planes of motion utilized in relation to the exercise.

At step 206, the system has all the information and data it needs to generate a complete analysis of the exercise and rank the exercise according to one or more exercise ranking classifications. The system will then generate the ranking based on said one or more exercise ranking classifications and provide the user with the ranking The system may be further configured to present to the user a detailed report related to the ranking and what characteristics of the exercise were utilized in generating the ranking

The process terminates at step 207. The steps herein provided are for example purposes only and may be executed in numerous alternate orderings.

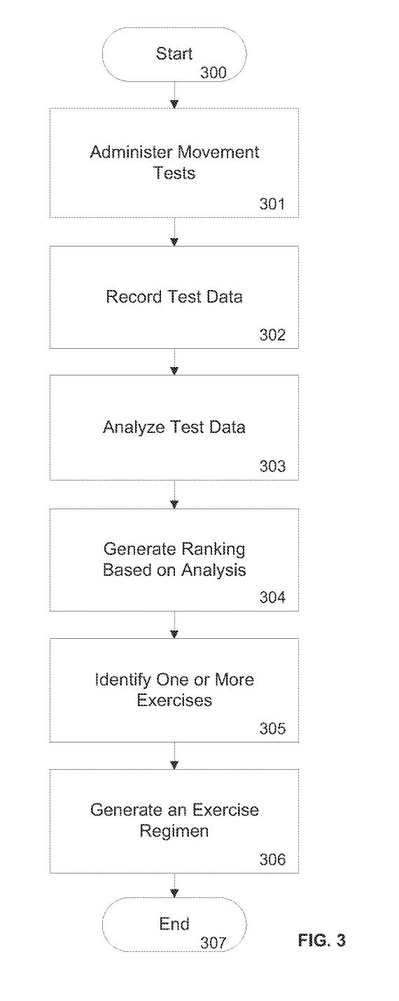

Turning now to FIG. 3, an exemplary embodiment of a method in accordance with the present invention is shown. The process starts at step 300, when the system is accessed by a user. At step 301, movement tests are administered to an individual.

At step 302, the system records test data for processing and analysis by the system. In this manner, step 302 may run concurrently with step 301. In an exemplary embodiment, the system may be configured to record this test data as digital video or any form of digital graphic medium.

At step 303, the system analyzes the test data recorded in step 302. The system may analyze the test data in a manner consistent with the methods described above. The analysis may be done on one or more levels. For instance, analysis may be done on individual areas or regions of the individual's body, analysis may be done on the individual as a whole or analysis may be done on any combination thereof.

At step 304, the system generates a ranking for the individual based on one or more individual ranking classification systems. The system may be further configured to present to the user a detailed report related to the ranking and what characteristics of the individual were utilized in generating the ranking For instance, one or more individual ranking classifications may be assigned to a single individual based on strengths and weaknesses identified in the various areas or regions of the individual's body. Moreover, a total or overall individual ranking classification may also be assigned to an individual.

At step 305, the system identifies one or more exercises appropriate for the individual based on the individual's overall ranking, one or more of the individual's ranking classifications, or any combination thereof. In this manner, previously identified and ranked exercises may be provided to the individual where the individual ranking classification and exercise ranking classification are compatible.

At step 306, the system may be configured to provide an entire exercise regimen to the individual, where the exercise regimen is comprised of a one or more of said one or more previously identified and ranked exercises. Optionally, prior to generation of the exercise regimen, the individual may be provided the opportunity to enter one or more characteristics in order to receive an exercise regimen that is best suited to their needs and desires. For instance, an individual may desire a exercise regimen of a specific duration, a specific difficulty or with a specific target goal in mind (e.g., increase stamina, increase mass, decrease mass, decrease body fat).

The process terminates at step 307. The steps herein provided are for example purposes only and may be executed in numerous alternate orderings.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented method for analyzing and ranking the difficulty of an exercise, comprising the steps of:
using a computing device to determining a variable set;
identifying, with said computing device, one or more joints utilized in an exercise;
analyzing, with said computing device, a degree of freedom value,
wherein said degree of freedom value is determined at least in part from said one or more joints utilized in an exercise;
analyzing, with said computing device, a movement speed of said exercise;
analyzing, with said computing device, one or more planes of motion associated with said exercise;
generating an exercise ranking classification, with said computing device, wherein said exercise ranking classification is based at least in part on said one or more planes of motion, said degree of freedom value, said one or more joints utilized in said exercise and said movement speed of said exercise;
displaying said exercise ranking classification.

2. The method of claim 1, wherein said exercise ranking classification is a difficulty scale.

3. The method of claim 1, wherein said exercise ranking classification is a numeric scale.

4. The method of claim 1, wherein said degree of freedom value is between one and three.

5. The method of claim 1, further comprising the step of storing said exercise ranking classification in said computing device.

6. The method of claim 1, further comprising the steps of:
generating, with said computing device, a detailed report based at least in part on said one or more planes of motion, said degree of freedom value, said one or more joints utilized in said exercise and said movement speed of said exercise; and
displaying said detailed report.

7. The method of claim 6, further comprising the step of storing said detailed report in said computing device.

8. A system for analyzing and ranking the difficulty of an exercise, said system comprising:
administering one or more movement tests to an individual;
using a computing device to record test data associated with said one or more movement tests;
analyzing said test data,
wherein said test data is analyzed on one or more variables;
generating an individual ranking classification, with said computing device, wherein said individual ranking classification is based at least in part on analysis of said test data; and
identifying one or more exercises,
wherein said one or more exercises are of a exercise ranking classification appropriate for said individual based at least upon said individual ranking classification.

9. The method of claim 8, wherein said individual ranking classification is a difficulty scale.

10. The method of claim 8, wherein said individual ranking classification is a numeric scale.

11. The method of claim 8, further comprising the step of generating an exercise regimen based at least in part on said one or more exercises.

12. The method of claim 11, further comprising the step of storing said exercise regimen in said computing device.

13. The method of claim 11, further comprising the step of displaying said exercise regimen.

14. The method of claim 8, further comprising the step of storing said individual ranking classification in said computing device.
